(19) United States
(12) Patent Application Publication
(10) Pub. No.: US 2025/0226906 A1
(43) Pub. Date: Jul. 10, 2025

(54) Clock connection topology discovery

(71) Applicant: Mellanox Technologies, Ltd., Yokneam (IL)

(72) Inventors: Natan Manevich, Nesher (IL); Dotan David Levi, Kiryat Motzkin (IL); Bar Or Shapira, Tel Aviv (IL); Ariel Almog, Kochav Yair (IL); Nir Laufer, Zoran (IL)

(21) Appl. No.: 18/406,154

(22) Filed: Jan. 7, 2024

(51) Int. Cl. H04J 3/06; H04L 43/50

(52) U.S. Cl. CPC H04J 3/0697; H04J 3/0658; H04L 43/50

(57) ABSTRACT

In some embodiments, a system includes a plurality of compute nodes, clock connections to connect at least some of the compute nodes and to distribute a master clock among the at least some compute nodes, and processing circuitry to discover a clock distribution topology formed by the compute nodes and the clock connections.

### FIELD OF THE INVENTION

The present invention relates to computer systems, and in particular, but not exclusively to, clock synchronization.

### BACKGROUND

Clock and frequency synchronization among network devices is used in many network applications. One application of using a synchronized clock value is for measuring latency between two devices. If the clocks are not synchronized the resulting latency measurement will be inaccurate.

Synchronous Ethernet (SyncE) is an International Telecommunication Union Telecommunication (ITU-T) Standardization Sector standard for computer networking that facilitates the transference of clock signals over the Ethernet physical layer. In particular, SyncE enables clock synchronization inside a network with respect to a master clock.

The actual clock value (e.g., in Coordinated Universal Time (UTC) format) is handled by higher layer standards and protocols, such as Precision Time Protocol (PTP). Precision Time Protocol (PTP) is a protocol used to synchronize clocks throughout a computer network, and is considered to be the de facto standard for this purpose.

Time, clock, and frequency synchronization are crucial in some modern computer network applications. They enable 5G and 6G networks, and are proven to enhance the performance of data center workloads.

### SUMMARY

There is provided in accordance with an embodiment of the present disclosure, a system, including a plurality of compute nodes, clock connections to connect at least some of the compute nodes and to distribute a master clock among the at least some compute nodes, and processing circuitry to discover a clock distribution topology formed by the compute nodes and the clock connections.

Further in accordance with an embodiment of the present disclosure the processing circuitry is to identify the discovered clock distribution topology as including a loop topology wherein the clock connections connect the compute nodes in a loop such that the compute nodes are configured to distribute the master clock around the loop from one of the compute nodes to another one of the compute nodes. Still further in accordance with an embodiment of the present disclosure the processing circuitry is to identify the discovered topology as including a chain topology wherein the clock connections connect the compute nodes in a chain such that the compute nodes are configured to distribute the master clock along the chain from one of the compute nodes to another one of the compute nodes.

Additionally in accordance with an embodiment of the present disclosure the processing circuitry is to identify the discovered topology as including a tree topology wherein the clock connections connect the compute nodes from a root node of the compute nodes to other ones of the compute nodes.

Moreover, in accordance with an embodiment of the present disclosure the processing circuitry is to identify the discovered topology as including a tree topology, a chain topology, and a loop topology.

Further in accordance with an embodiment of the present disclosure the processing circuitry is to validate the discovered clock distribution topology as being the same as an expected clock distribution topology.

Still further, in accordance with an embodiment of the present disclosure the processing circuitry is to check that the discovered topology allows distribution of the master clock from one of the compute nodes to all remaining ones of the compute nodes.

Additionally in accordance with an embodiment of the present disclosure the processing circuitry is to identify one of the compute nodes that cannot receive the master clock from a root node of the compute nodes.

Moreover, in accordance with an embodiment of the present disclosure the processing circuitry is to cause the compute nodes to send out test signals along the clock connections, the compute nodes are to detect receipt of the test signals, and the processing circuitry is to discover the topology based on the detected receipt of the test signals.

Further in accordance with an embodiment of the present disclosure the processing circuitry is to identify source and destination compute nodes of the test signals based on the detected receipt of the test signals, find at least one route along the clock connections from a root node of the compute nodes to all remaining ones of the compute nodes based on the identified source and destination compute nodes of the test signals, and discover the topology based on the found at least one route.

Still further in accordance with an embodiment of the present disclosure the processing circuitry is to selectively disable output of clock signals generated by the compute nodes in order to enable the compute nodes to output the clock signals one at a time to yield the test signals.

Additionally in accordance with an embodiment of the present disclosure the clock signals include pulses that indicate clock time.

Moreover, in accordance with an embodiment of the present disclosure the clock signals are n pulse per second (PPS) signals, wherein n is a positive integer.

Further in accordance with an embodiment of the present disclosure the clock signals have a frequency indicative of clock frequency.

Still further in accordance with an embodiment of the present disclosure each of the compute nodes includes hardware logic to determine receipt, or lack of receipt, of one of the test signals.

The system, where the distributed master clock is indicative of a frequency of a master clock.

Additionally in accordance with an embodiment of the present disclosure the distributed master clock is indicative of a time of a master clock.

Moreover, in accordance with an embodiment of the present disclosure the compute nodes include corresponding network interface controllers. Further in accordance with an embodiment of the present disclosure the compute nodes include corresponding central processing units.

Still further in accordance with an embodiment of the present disclosure the compute nodes include corresponding graphic processing units.

Additionally in accordance with an embodiment of the present disclosure the compute nodes include corresponding network switches.

There is also provided in accordance with another embodiment of the present disclosure, a method, including connecting compute nodes with clock connections to distribute a master clock among the compute nodes, and discovering a clock distribution topology formed by the compute nodes and the clock connections.

### BRIEF DESCRIPTION OF THE DRAWINGS

The present invention will be understood from the following detailed description, taken in conjunction with the drawings in which:

FIG. 1 is a block diagram view of a clock synchronization system constructed and operative in accordance with an embodiment of the present invention;

FIG. 2 is a block diagram view of the system of FIG. 1 showing a different compute node assigned as the local reference clock;

FIG. 3 is a block diagram view of the system of FIG. 1 with a first alternative clock connection arrangement;

FIG. 4 is a block diagram view of the system of FIG. 1 with a second alternative clock connection arrangement;

FIG. 5 is a block diagram view of the system of FIG. 1 with a third alternative clock connection arrangement and one compute node designated as a local reference clock;

FIG. 6 is a block diagram view of the system of FIG. 5 with another compute node designated as the local reference clock;

FIG. 7 is a block diagram view of a clock synchronization system with one compute node designated as a master clock constructed and operative in accordance with an embodiment of the present invention;

FIG. 8 is a block diagram view of the clock synchronization system of FIG. 7 with another compute node designated as the master clock;

FIG. 9 is a block diagram view of processing circuitry of a compute node for use in the system of FIG. 1; and

FIG. 10 is a flowchart including steps in a method to discover a clock distribution topology for use with the system of FIG. 1.

### DESCRIPTION OF EXAMPLE EMBODIMENTS

### Overview

Clock synchronization between network devices remains a challenge in the networking industry due to continued demand for tighter clock synchronization. One solution is to chain multiple devices together so that a reference or master clock time or frequency is distributed from one network device at the root of the chain to other network devices in the chain. The root is defined by wiring topology. In some cases, the devices may be connected in a loop so that any of the devices may be defined as the root for distribution of a master clock time or frequency. The devices may be connected in a tree (including a chain) or loop topology, or any suitable combination thereof. For example, the topology may include a tree topology with one or more sub-loops in the tree topology.

The application which controls and orchestrates the devices needs to be aware of the topology. For example, in order to be able to assign a local master device, which then distributes the master clock to the other devices. In general, the use of clock chaining relies on knowing the topology of the clock connections between the devices and/or that the actual topology is the same as the expected topology and/or that the actual topology allows a given master clock distribution method to be applied among the devices. If there is a mismatch between the actual topology and the expected topology or if the actual topology does not allow the master clock to be distributed to all the devices in the system, then the system will not work correctly.

Some hardware components can also stop behaving as expected. For example, a cable which is used to connect two devices may stop working. This can lead to improper system behavior, and the root cause of the problem may not be easy to detect.

Therefore, embodiments of the present invention address at some of the above drawbacks by providing a system which discovers the clock distribution topology of compute nodes to determine how the compute nodes are connected for clock distribution purposes via various clock connections (e.g., clock cables and/or traces on a printed circuit board). The discovered topology may be used to determine a clock distribution method and/or to determine which compute node to assign as a master or root node from which to distribute the master clock. In some embodiments, the discovered topology may be compared to an expected topology and/or to ensure that the discovered topology allows distribution of the master clock from a root node of the compute nodes to all other compute nodes in the system. In some embodiments, compute nodes not connected to, or incorrectly connected to, the clock distribution topology may be identified and reported. A compute node may be any suitable device or entity providing computational functionality.

In some embodiments, the compute nodes may be network devices including network interface controller (NIC) application-specific integrated circuits (ASICs), or processing devices including central processing units (CPUs) and/or graphic processing units (GPUs), or network switches including switch circuitry.

In some embodiments, the compute nodes send out test signals along the clock connections, for example, by selectively disabling output of clock signals generated by the compute nodes in order to enable the compute nodes to output the clock signals one at a time to yield the test signals. The clock signals may include pulses (e.g., pulse per second (PPS) signals) that indicate clock time, or clock signals having a frequency indicative of clock frequency. The compute nodes detect receipt of the test signals. Each compute node may include hardware logic to determine receipt, or lack of receipt, of the test signals, as described in disclosed embodiments.

The system then discovers the clock distribution topology based on the detected receipt of the test signals. For example, the system may identify source and destination compute nodes of the test signals based on the detected receipt of the test signals and find at least one route along the clock connections from a root node of the compute nodes to all remaining ones of the compute nodes based on the identified source and destination compute nodes of the test signals, the route(s) being indicative of the clock distribution topology.

### System Description

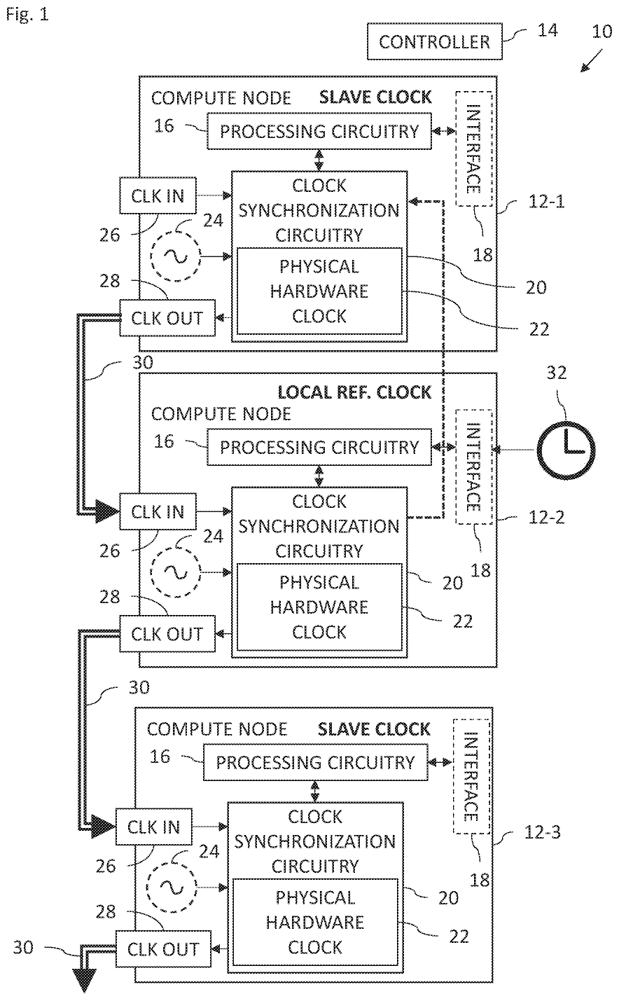

FIGS. 1-8 describe various different example clock distribution topologies formed from compute nodes 12 connected together using clock connections 30. The clock connections 30 are configured to connect the compute nodes 12 and to distribute a master clock (indicative of a master clock time or a master clock frequency) among the compute nodes 12. In some embodiments, the clock connections may be dedicated clock connections for conveying clock time or clock frequency (as opposed to network connections which carry other data). Apart from the example topologies described with reference to FIGS. 1-8, any suitable clock distribution topology may be used with embodiments of the present invention, including suitable combinations of any of the topologies described with reference to FIGS. 1-8.

Reference is now made to FIG. 1, which is a block diagram view of a clock synchronization system 10 constructed and operative in accordance with an embodiment of the present invention.

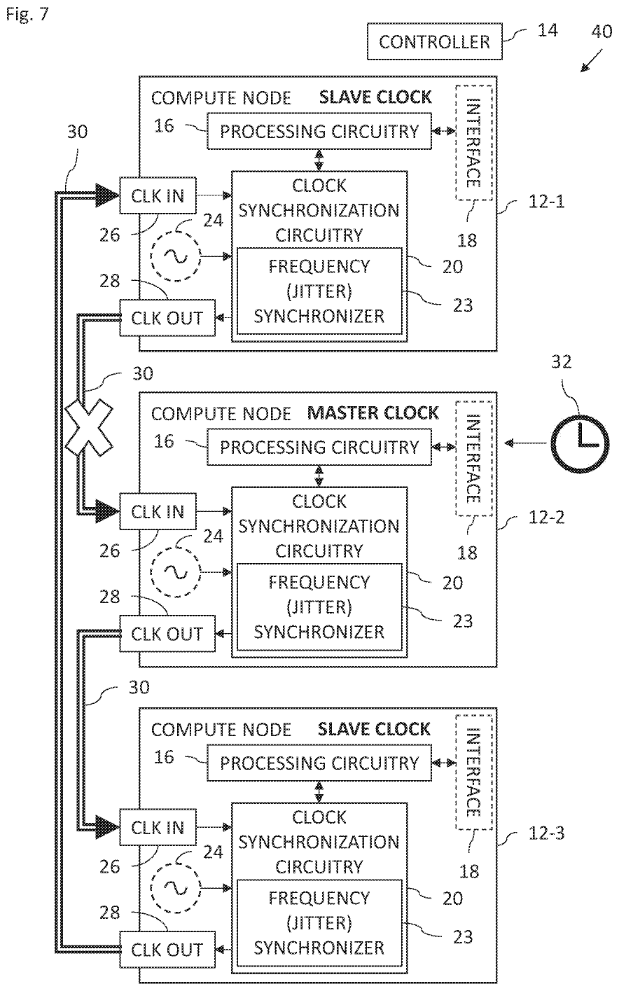

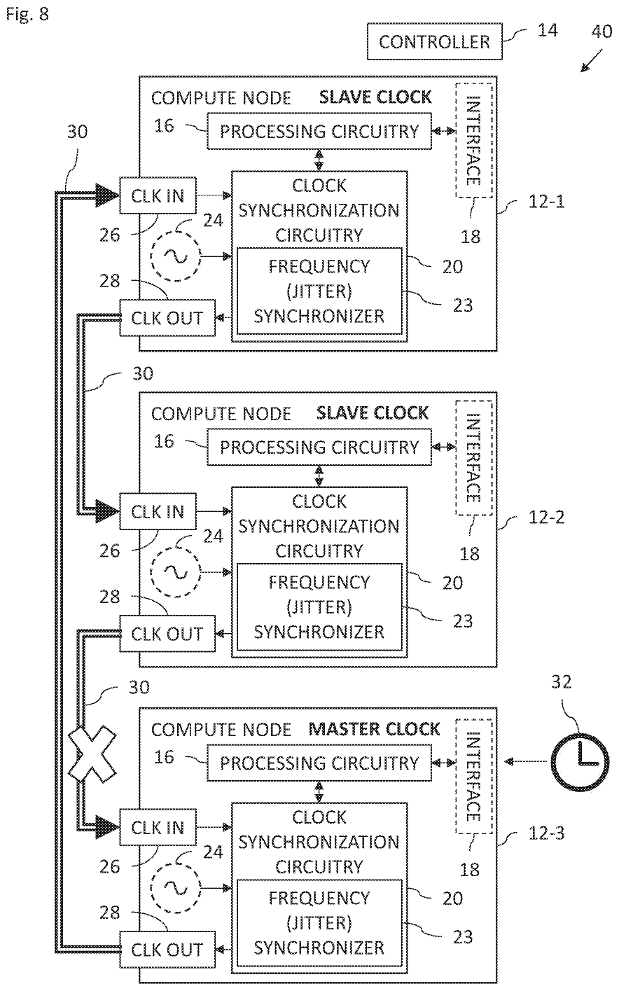

The system 10 includes a plurality of compute nodes 12 (labeled compute nodes 12-1, 12-2, 12-3), and a controller 14. Each compute node 12 may include processing circuitry 16, a network interface 18, clock synchronization circuitry 20, a physical hardware clock 22, an oscillator 24, a clock input port 26, and a clock output port 28. In some embodiments, each compute node 12 may include a frequency synchronizer 23, instead of, or in addition to, the physical hardware clock 22, as described with reference to FIGS. 7 and 8. In some embodiments, the oscillator 24 may be replaced by a digital controlled oscillator (DCO), which is configured to generate a local clock having a local clock frequency. SiT5377 is a ±100 ppb precision MEMS Super-TCXO and is suitable for use as DCO. SiT5377 is commercially available from SiTime Corporation, 5451 Patrick Henry Drive, Santa Clara, CA 95054, USA.

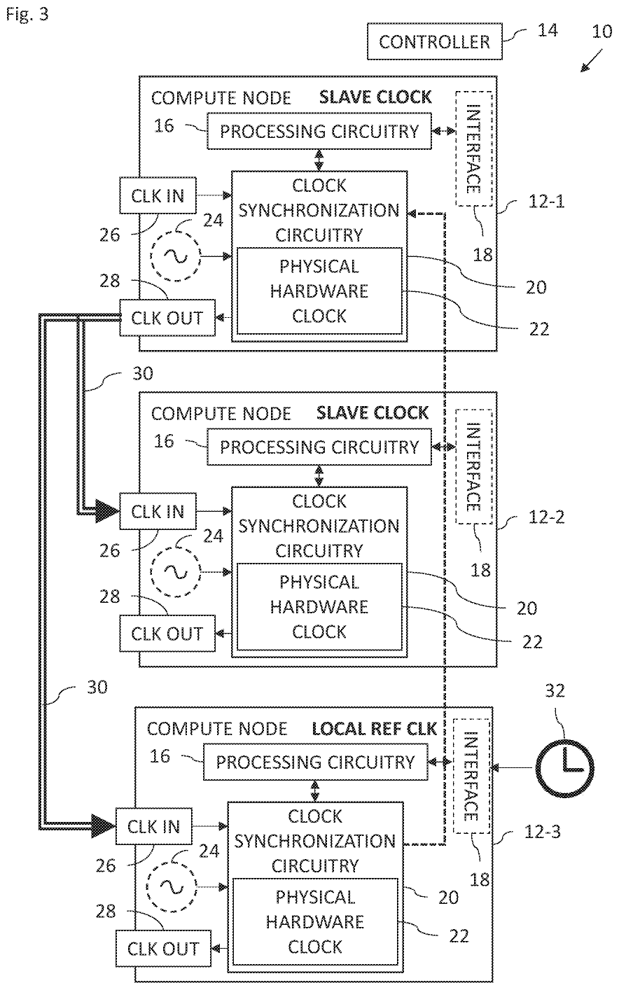

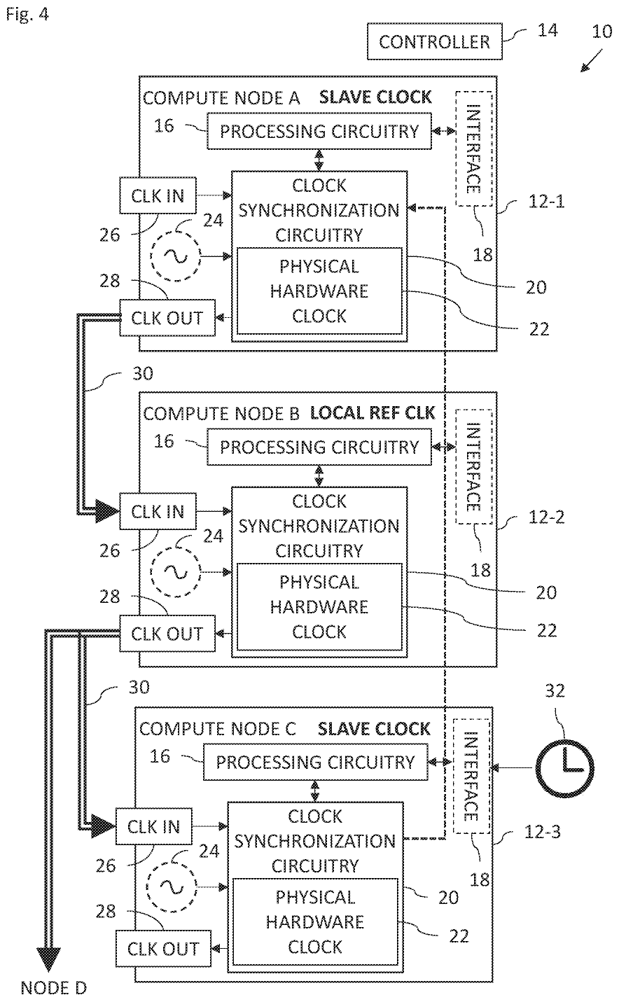

A plurality of clock connections 30 are configured to connect the compute nodes 12 in a daisy chain formation. For example, compute node 12-1 is connected to compute node 12-2, which is connected to compute node 12-3, which in turn may be connected to another compute node (not shown), and so on. In the example of FIG. 1, the clock output port 28 of compute node 12-1 is connected to the clock input port 26 of compute node 12-2 via a first clock connection 30, and the clock output port 28 of compute node 12-2 is connected to the clock input port 26 of compute node 12-3 via a second clock connection 30, and so on. Any suitable tree topology can be implemented to connect the compute nodes 12 of the scalable boundary clock system 10 together, as described in more detail with reference to FIGS. 3 and 4. The compute nodes 12 may be connected as “one to many”, “one to one”, or any suitable combination thereof. The root of the tree may be considered to be the “root compute node 12” or a “PPS synchronization master”.

The system 10 may include more than (or less than) three compute nodes 12 connected together. The compute nodes 12 may be disposed on the same printed circuit board (not shown) with the clock connections 30 being implemented using printed circuit board (PCB) traces (not shown) on the circuit board between the compute nodes 12.

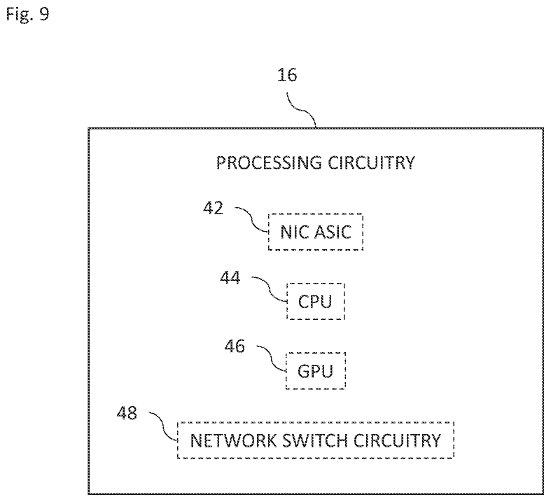

The processing circuitry 16 and the clock synchronization circuitry 20 may include hardwired processing circuitry and/or one or more processors on which to execute software. The software may be downloaded to the compute node 12 or disposed on the compute node 12 at manufacture. The processing circuitry 16 may include packet processing circuitry which may include a physical layer (PHY) chip and MAC chip (not shown). The processing circuitry 16 may include switching circuitry, and/or graphics processing unit (GPU) or any suitable processor, described in more detail with reference to FIG. 9. The compute node 12 may include a data processing unit (DPU) or SmartNIC. In some embodiments, the compute node 12 may be a network device.

In some embodiments, the network interface 18 is configured to receive packets over a network from a remote clock 32, which outputs a reference clock time. In some embodiments, any one of the compute nodes 12 is configured to recover the reference clock time from the packets according to the Precision Time Protocol (PTP). In some embodiments, the network interface 18 is configured to transmit and receive clock synchronization messages over at least one network link (e.g., from the remote clock 32), and the clock synchronization circuitry 20 is configured to process the clock synchronization messages so as to recover a remote clock time from the remote clock 32. The clock synchronization messages may be received via any suitable interface via any suitable communication method and/or protocol.

The physical hardware clock 22 may be implemented as any suitable hardware clock, for example, a PTP hardware clock. The physical hardware clock 22 may be implemented as a physical clock, which is stored on the device 12. In some embodiments, the physical hardware clock 22 may be implemented as a hybrid hardware and software clock in which hardware stores a free running clock (e.g., a hardware counter which is incremented), and software holds parameters which convert the hardware clock into the actual clock time. In some embodiments, when the physical hardware clock 22 is implemented as a hybrid hardware and software clock, the PTP or PHC time and frequency adjustments do not affect the physical free running clock, but only the conversion parameters. The reference clock time may be maintained in any suitable format, for example, in Coordinated Universal Time (UTC) format.

In the example of FIG. 1, The compute node 12-2 is designated as the local reference clock, for example by the controller 14. The compute node 12-2 is configured to receive packets from the remote clock 32. The compute node 12-2 is configured to recover the reference clock time from packets received from the remote clock 32. In some embodiments, the compute node 12-2 is configured to recover the reference clock time from the packets according to Precision Time Protocol (PTP). In some embodiments, the reference clock time is in Coordinated Universal Time (UTC) format. The compute node 12-2 is configured to find a clock differential between a clock time output by its physical hardware clock 22 and the recovered reference clock time. The compute node 12-2 is configured to provide a control signal to the root compute node 12-1 responsively to the clock differential. The control signal is typically sent to the compute node 12-2 via a system software interface of the system 10. In some embodiments, the control signal may be sent using an out-of-band communication mechanism, e.g., using I²C to exchange the control signal. The out-of-band communication mechanism may be applicable to appliances which host multiple networking chips on one board, e.g., a mezzanine board with multiple chips. The control signal provides instructions to the compute node 12-1 how to adjust the physical hardware clock 22 of the compute node 12-1. One or more of the above steps may be performed by the clock synchronization circuitry 20 of the compute node 12-2. In some embodiments, the clock synchronization circuitry 20 runs an instance of a PTP slave application (e.g., ptp4l slave) which performs one or more of the above steps.

The clock synchronization circuitry 20 of the compute node 12-1 is configured to receive the control signal from the compute node 12-2. The clock synchronization circuitry 20 of the compute node 12-1 is configured to adjust a clock time output by its physical hardware clock 22 (and/or a clock frequency of its physical hardware clock 22) responsively to the received control signal. In some embodiments, the clock synchronization circuitry 20 of the compute node 12-1 is configured to adjust the clock time output by its physical hardware clock 22 so as to iteratively reduce an absolute value of the clock differential between the clock time output by the physical hardware clock 22 of compute node 12-2 and the recovered reference clock time. The clock time of any of the physical hardware clocks 22 may be adjusted by adjusting the clock frequency. In some embodiments, the clock synchronization circuitry 20 of the compute node 12-1 is configured to adjust the clock frequency of its physical hardware clock 22 so as to iteratively reduce an absolute value of the clock differential between the clock time output by the physical hardware clock 22 of compute node 12-2 and the recovered reference clock time. The clock synchronization circuitry 20 of the compute node 12-2 is configured to generate a clock signal indicative of the clock time (and/or frequency) output by its physical hardware clock 22. In some embodiments a ptp4l master application generates the clock signal for sending via the clock output port 28 of the compute node 12-1. The clock output port 28 of the compute node 12-1 is configured to output the clock signal indicative of the clock time (and/or frequency) output by its physical hardware clock 22 via one of the clock connections 30 to the clock input port 26 of the compute node 12-2.

In some embodiments, the compute nodes 12 are configured to output the clock signals via the respective clock connections 30 in the form of any suitable signal e.g., using a pulsed signal such as N pulses per second, such as one pulse per second (PPS) signal(s) or 10 mega Hertz (10 MHz) signal(s). In some embodiments, the clock signals output via the clock connections 30 are analog signals while the control signal is a digital signal.

The clock input port 26 of the compute node 12-2 is configured to receive the clock signal via one of the clock connections 30. The clock synchronization circuitry 20 of the compute node 12-2 is configured to discipline its physical hardware clock 22 responsively to the received clock signal. In some embodiments, a ts2phc application running on the clock synchronization circuitry 20 synchronizes the physical hardware clock 22 of the compute nodes 12-2 to the received clock signal. When the clock signal is received, the current time of the physical hardware clock 22 is sampled by the clock synchronization circuitry 20, which provides the current time and time indicated in the received clock signal to the ts2phc application, which synchronizes the physical hardware clock 22 to the time indicated in the received clock signal by instructing the physical hardware clock 22 to run faster or slower.

The clock synchronization circuitry 20 of the compute node 12-2 is configured to generate a clock signal indicative of the clock time output by (and/or frequency of) its physical hardware clock 22. The clock output port 28 of the compute node 12-2 is configured to output the clock signal indicative of the clock time output by (and/or frequency of) its physical hardware clock 22 via one of the clock connections 30 to the clock input port 26 of the compute node 12-3.

The clock input port 26 of compute node 12-3 is configured to receive the clock signal (from compute node 12-2) via the clock connection 30. The clock synchronization circuitry 20 of the compute node 12-3 is configured to discipline its physical hardware clock 22 responsively to the received clock signal. The clock synchronization circuitry 20 of the compute node 12-3 is configured to generate a clock signal indicative of the clock time output by (and/or a frequency of) its physical hardware clock 22. The clock output port 28 of the compute node 12-3 is configured to output the clock signal indicative of the clock time output by (and/or a frequency of) its physical hardware clock 22 via and one of the clock connections 30 to the clock input port 26 of another compute node (not shown), and so on.

When the compute nodes 12 boot up, each compute node 12 looks for a clock signal being received at its own clock input port 26 and if a clock signal is not found, the respective compute node 12 uses a local clock, for example, based on an output of the oscillator 24 in that compute node 12. When one of the compute nodes 12 detects a clock signal input at its clock input port 26, that compute node 12 uses the received clock signal to discipline its physical hardware clock 22.

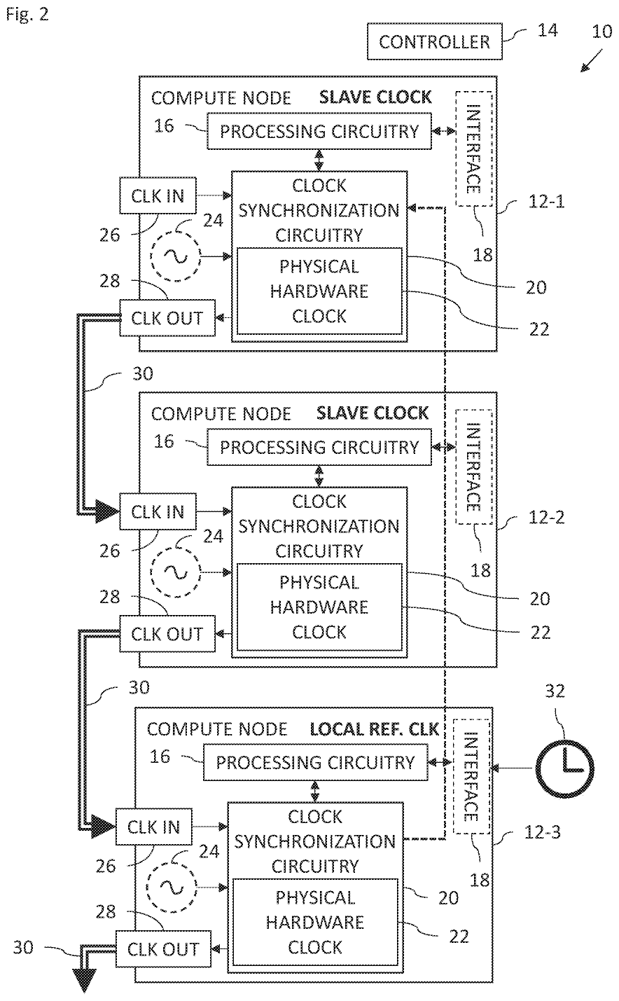

Reference is now made to FIG. 2, which is a block diagram view of the system 10 of FIG. 1 showing a different compute node assigned as the local reference clock. If the remote clock 32 goes down, and a new suitable master connected to compute node 12-3 is discovered, the compute node 12-3 is assigned by the controller 14 as the master compute node in the system 10. The compute node 12-3 recovers the reference clock time from the remote clock, finds the differential between the clock time of its physical hardware clock 22 and the recovered reference clock time, and provides a control signal to the root compute node 12-1, from which the reference clock time is distributed via the clock connections 30 to the compute nodes 12-2, 12-3. Any port of any of the compute nodes 12 may serve as the PTP time source for the chain of compute nodes 12.

Therefore, any one of the compute nodes 12 may be configured to selectively connect to the remote clock 32 or another remote clock, and to recover the reference clock time from packets received from the remote clock 32 or other remote clock. In other words, any of the compute nodes 12 can be the local reference clock or one of the slave clocks.

Reference is now made to FIG. 3, which is a block diagram view of the system 10 of FIG. 1 with a first alternative clock connection arrangement. In FIG. 3 the clock output port 28 of the root compute node 12-1 is directly connected by two clock connections 30 to the clock input ports 26 of the compute nodes 12-2, 12-3. The clock synchronization circuitry 20 generates the same clock signal for sending to both compute nodes 12-2, 12-3 via clock connections 30 to the clock input ports 26 of the compute nodes 12-2, 12-3. The clock synchronization circuitry 20 of the compute node 12-1 is configured to receive the control signal from the compute node 12-3, and discipline its physical hardware clock 22 responsively to the control signal. The clock output port 28 of the compute node 12-1 is configured to output a clock signal indicative of the clock time output by its physical hardware clock 22 via the clock connections 30 to the compute nodes 12-2, 12-3. Each non-root compute node 12-2, 12-3 is configured to receive the clock signal via its clock input port 26 from the root compute node 12-1, and discipline its physical hardware clock 22 responsively to the received clock signal.

Reference is now made to FIG. 4, which is a block diagram view of the system 10 of FIG. 1 with a second alternative clock connection arrangement. The arrangement of FIG. 4 shows one of the clock connections 30 connecting the clock output port 28 of compute node 12-1 to the clock input port 26 of compute node 12-2, and more clock connections 30 connecting the clock output port 28 of compute node 12-2 to the clock input ports 26 of the compute node 12-3 and another compute node (not shown).

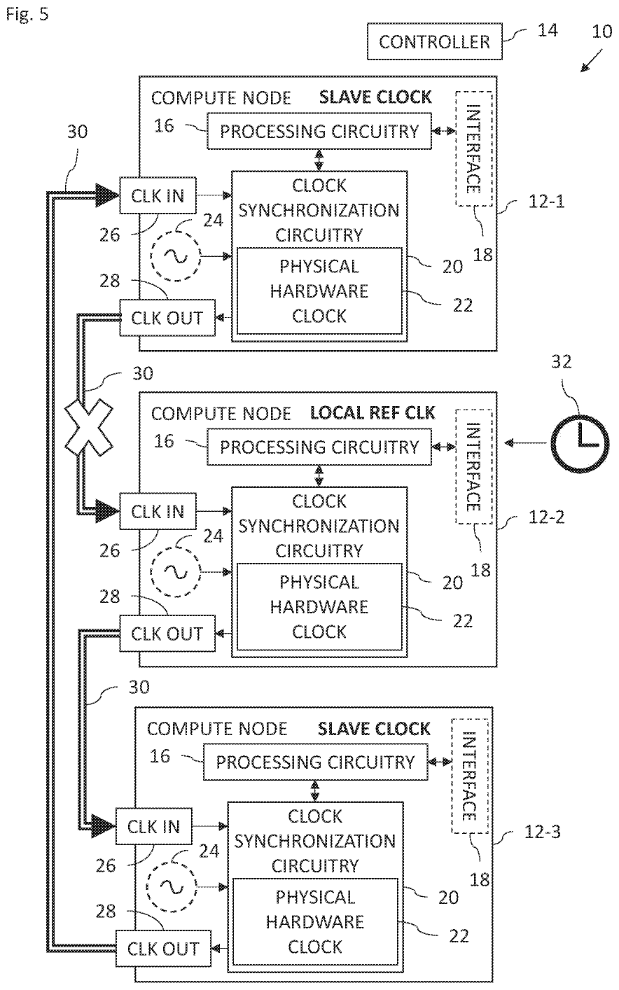

Reference is now made to FIG. 5, which is a block diagram view of the clock synchronization system 10 of FIG. 1 and compute node 12-2 being designated as a local reference clock. In FIG. 5, the clock connections 30 are configured to connect the compute nodes 12 in a closed loop configuration. For example, compute node 12-1 is connected to compute node 12-2, which is connected to compute node 12-3, which in turn is connected to compute node 12-1 via the clock connections 30 as described in more detail below. FIG. 5 shows three compute nodes 12 connected together in a closed loop configuration. The system 10 may include two compute nodes 12 connected together in a closed loop configuration. The system 10 may include more than three compute nodes 12 connected together in a closed loop configuration.

The clock input port 26 of one of the compute nodes 12 (e.g., compute node 12-1) is connected to the clock output port 28 of another one of the compute nodes 12 (e.g., compute node 12-3) via one of the clock connections 30, and configured to receive a clock signal indicative of the reference clock time from the other compute node 12 (e.g., compute node 12-3). The clock output port 28 of one of the compute nodes 12 (e.g., compute node 12-1) is connected to the clock input port 26 of another one of the compute nodes 12 (e.g., compute node 12-2) via one of the clock connections 30. The clock output port 28 of the compute node 12-2 is connected to the clock input port 26 of the compute node 12-3 via one of the clock connections 30.

In general, the compute nodes 12 are configured to distribute among the compute nodes 12 the reference clock time from any selected one of the compute nodes, for example, the computer node 12-2 designated as the local reference clock. The reference clock time may be maintained in any suitable format, for example, in Coordinated Universal Time (UTC) format.

In the example of FIG. 5, the compute node 12-2 disciplines its physical hardware clock 22 to the reference clock time responsively to the recovered remote clock time recovered from the remote clock 32. The compute node 12-2 is designated as the local reference clock, for example by the controller 14. The compute node 12-2 distributes a time of its physical hardware clock 22 in a clock signal via the clock output port 28 of compute node 12-2 to the clock input port 26 of compute node 12-3. The compute node 12-3 disciplines its physical hardware clock 22 responsively to the received clock signal received at the clock input port 26 of compute node 12-3. The compute node 12-3 distributes the time of its physical hardware clock 22 in a clock signal via the clock output port 28 of compute node 12-3 to the clock input port 26 of compute node 12-1. The compute node 12-1 disciplines its physical hardware clock 22 responsively to the received clock signal received at the clock input port 26 of compute node 12-1. In some embodiments, the compute node 12-1 is instructed by the controller 14 not to distribute the clock signal via the clock output port 28 of compute node 12-1. In other embodiments, the compute node 12-1 distributes the clock signal via the clock output port 28 of compute node 12-1 to the clock input port 26 of compute node 12-2, which is instructed by the controller 14 to ignore the received clock signal received at the clock input port 26 of compute node 12-2. It should be noted that disciplining the physical hardware clocks 22 may include speeding up or slowing down the clocks 22 in order to reach the desired time (e.g., the reference clock time). The compute nodes 12 may be configured to distribute the reference clock time via respective clock connections 30 in the form of any signal e.g., using N pulses per second, such as one pulse per second (PPS) signal(s) or 10 mega Hertz (10 MHz) signal(s).

In the compute node 12-2 designated as the local reference clock, the compute node 12-2 disciplines its physical hardware clock 22 to provide a clock time based on a clock time recovered from the remote clock 32. In the compute node(s) 12-1, 12-3 not designated as the local reference clock, the clock signal received at the clock input port 26 is used to discipline the respective physical hardware clock 22.

In some embodiments, software or firmware running on the controller 14 breaks the chain of the closed loop so that the compute node 12-2 designated as the local reference clock does not use a clock signal received at its clock input port 26 or does not receive a clock signal at its clock input port 26.

When the compute nodes 12 boot up, each compute node 12 looks for a clock signal being received at its own clock input port 26 and if a clock signal is not found, the respective compute node 12 uses a local clock, for example, based on an output of the oscillator 24 in that compute node 12. Therefore, the first compute node 12 to boot up outputs a clock signal based on its physical hardware clock 22 from its clock output port 28 to the next compute node 12 in the closed loop. The next compute node 12 then detects the clock signal input via its clock input port 26 and uses the received clock signal to discipline its physical hardware clock 22, and so on. When one of the compute nodes 12 is designated as a local reference clock, that compute node 12 does not use the clock signal received at its clock input port 26, but disciplines its physical hardware clock 22 based on the remote clock 32 and outputs a clock signal indicative of the clock value of its physical hardware clock 22 via its clock output port 28 to the next compute node 12 in the loop, and so on. Another option is to assign one of the compute nodes 12 as a default local reference clock.

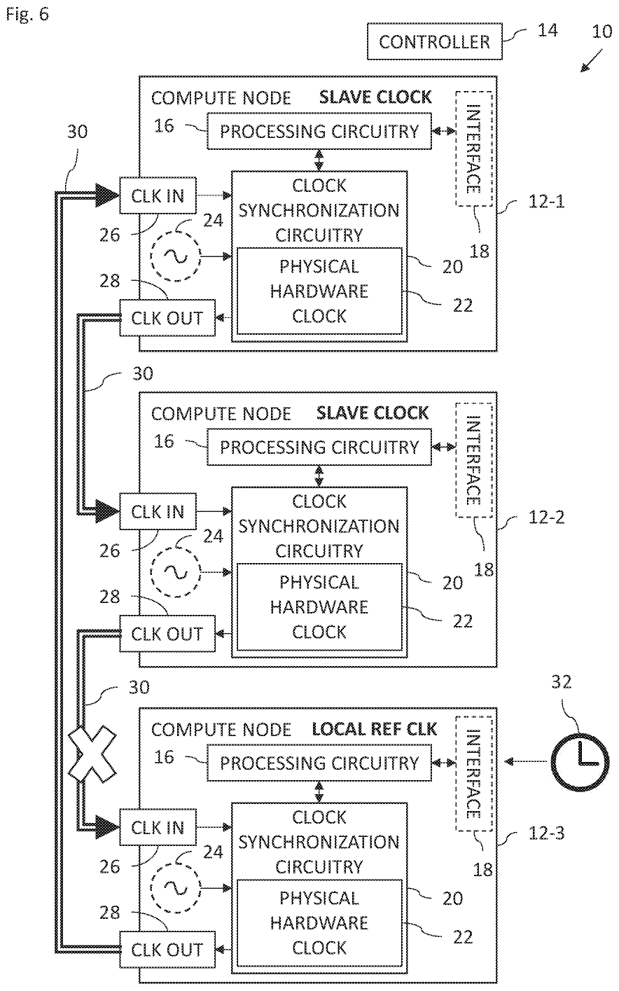

Reference is now made to FIG. 6, which is a block diagram view of the clock synchronization system 10 of FIG. 5 with compute node 12-3 designated as the local reference clock. The local reference clock may be moved from one compute node 12 to another due to many reasons, for example, the remote clock 32 used by one of the compute nodes 12 previously designated as the local reference clock may now be non-functional or deemed to be less accurate than a remote clock used by another one of the compute nodes 12 now designated as the local reference clock.

In the example of FIG. 6, the compute node 12-3 is now designated as the local reference clock (for example, by the controller 14), and disciplines its physical hardware clock 22 from the remote clock 32. The compute node 12-3 may: ignore any clock signal received at its clock input port 26; or the controller 14 may instruct the compute node 12-2 to cease outputting a clock signal via the clock output port 28 of compute node 12-2. The compute node 12-3 distributes a clock signal indicative of the clock time of its physical hardware clock 22 via the clock output port 28 of compute node 12-3 to the clock input port 26 of the compute node 12-1. The compute node 12-1 disciplines its physical hardware clock 22 responsively to the received clock signal received at the clock input port 26 of compute node 12-1. The compute node 12-1 distributes a clock signal indicative of the clock time of its physical hardware clock 22 via the clock output port 28 of compute node 12-1 to the clock input port 26 of compute node 12-2. The compute node 12-2 disciplines its physical hardware clock 22 responsively to the received clock signal received at the clock input port 26 of compute node 12-2. As mentioned above, in some embodiments, the compute node 12-2 is instructed by the controller 14 not to distribute a clock signal via the clock output port 28 of compute node 12-2. In other embodiments, the compute node 12-2 distributes a clock signal indicative of the clock time of its physical hardware clock 22 via the clock output port 28 of compute node 12-2 to the clock input port 26 of compute node 12-3, which is instructed by the controller 14 to ignore the received clock signal received at the clock input port 26 of compute node 12-3.

In some embodiments, the controller 14 is configured to run a software daemon which knows the topology of the system 10 (i.e., how the compute nodes 12 are connected in the closed loop) and which compute node 12 is the local reference clock (e.g., PTP master) so that the software daemon knows where to block and unblock the closed loop. If the compute nodes 12 are disposed in different hosts, then the hosts may need to communicate with respect to blocking and unblocking the closed loop.

Reference is now made to FIG. 7, which is a block diagram view of a clock synchronization system 40 with one compute node 12-2 designated as a master clock constructed and operative in accordance with an embodiment of the present invention. The clock synchronization system 40 is substantially the same as the system 10 described above, except for the following differences. Each compute node 12 includes frequency synchronizer 23 instead of physical hardware clock 22. The clock connections 30 are configured to connect the compute nodes 12 in a closed loop configuration. For example, compute node 12-1 is connected to compute node 12-2, which is connected to compute node 12-3, which in turn is connected to compute node 12-1 via the clock connections 30 as described in more detail below.

FIG. 7 shows compute nodes 12 connected together in a closed loop configuration. The system 40 may include two compute nodes 12 connected together in a closed loop configuration. The system 40 may include more than three compute nodes 12 connected together in a closed loop configuration. The compute nodes 12 may be disposed on the same printed circuit board (not shown) with the clock connections 30 being implemented using printed circuit board (PCB) traces (not shown) on the circuit board between the compute nodes 12.

The clock input port 26 of one of the compute nodes 12 (e.g., compute node 12-1) is connected to the clock output port 28 of another one of the compute nodes 12 (e.g., compute node 12-3) via one of the clock connections 30, and configured to receive a clock signal at the master clock frequency from the other compute node 12 (e.g., compute node 12-3). The clock output port 28 of one of the compute nodes 12 (e.g., compute node 12-1) is connected to the clock input port 26 of another one of the compute nodes 12 (e.g., compute node 12-2) via one of the clock connections 30. The clock output port 28 of the compute node 12-2 is connected to the clock input port 26 of the compute node 12-3 via one of the clock connections 30.

In general, the compute nodes 12 are configured to distribute among the compute nodes 12 a master clock frequency from any selected one of the compute nodes, for example, the computer node 12-2 designated as the master clock.

In the example of FIG. 7, the compute node 12-2 disciplines its local clock signal from the remote clock 32 and is designated as the master clock, for example by the controller 14. The compute node 12-2 distributes its local clock signal as the master clock frequency via the clock output port 28 of compute node 12-2 to the clock input port 26 of compute node 12-3. The compute node 12-3 disciplines its local clock signal responsively to the received clock signal received at the clock input port 26 of compute node 12-3. The compute node 12-3 distributes its local clock signal as the master clock frequency via the clock output port 28 of compute node 12-3 to the clock input port 26 of compute node 12-1. The compute node 12-1 disciplines its local clock signal responsively to the received clock signal received at the clock input port 26 of compute node 12-1. In some embodiments, the compute node 12-1 is instructed by the controller 14 not to distribute its local clock signal via the clock output port 28 of compute node 12-1. In other embodiments, the compute node 12-1 distributes its local clock signal as the master clock frequency via the clock output port 28 of compute node 12-1 to the clock input port 26 of compute node 12-2, which is instructed by the controller 14 to ignore the received clock signal received at the clock input port 26 of compute node 12-2.

The compute nodes 12 may be configured to distribute the master clock frequency via respective clock connections 30 in the form of any signal which is scaled proportional to master clock frequency using one pulse per second (PPS) signal(s) or 10 mega Hertz (10 MHz) signal(s). The scaling factor may be used by the clock synchronization circuitry 20 of the outputting compute node 12 to scale the master clock frequency to one PPS or 10 MHz, for example, and by the clock synchronization circuitry 20 of the receiving compute node 12 to rebuild the received signal (e.g., one PPS or 10 MHz) to the master clock frequency.

In some embodiments, the frequency synchronizer 23 is a frequency jitter synchronizer or a jitter network synchronizer clock. The frequency synchronizer 23 may be configured to tune a network frequency, feed the clock of the compute node 12, and provide phase lock loop (PLL) capabilities. In some embodiments, the frequency synchronizer 23 includes an application-specific integrated circuit (ASIC) and/or a programmable device with analog circuitry mainly for phase lock loop (PLL) capabilities. The frequency synchronizer 23 may be a low or ultra-low frequency jitter synchronizer. An example of a suitable frequency synthesizer is Ultra-Low Jitter Network Synchronizer Clock LMK05318 commercially available from Texas Instruments Inc., 12500 TI Boulevard, Dallas, Texas 75243 USA.

In compute node 12-2, designated as the master clock, the frequency synchronizer 23 adjusts the output of the oscillator 24 to provide a local clock signal based on a clock recovered from the remote clock 32. In compute node(s) 12-1, 12-3 not designated as the master clock, the clock signal received at the clock input port 26 is used by the frequency synchronizer 23 to drive the local clock signal, generally without using the output of the oscillator 24.

In some embodiments, the frequency synchronizer 23 is configured to use the clock signal received at the clock input port 26 if such a clock signal is received. If not, the frequency synchronizer 23 disciplines the local clock signal based on the output of the oscillator 24 and/or a recovered remote clock. Therefore, in some embodiments, software or firmware running on the controller 14 breaks the chain of the closed loop so that the compute node 12-2 designated as the master clock does not use a clock signal received at its clock input port 26 or does not receive a clock signal at its clock input port 26.

When the compute nodes 12 boot up, each compute node 12 looks for a clock signal being received at its own clock input port 26 and if a clock signal is not found, the respective compute node 12 uses a local clock, for example, based on an output of the oscillator 24 in that compute node 12. Therefore, the first compute node 12 to boot up outputs a clock signal based on a local clock from its clock output port 28 to the next compute node 12 in the closed loop. The next compute node 12 then detects the clock signal input via its clock input port 26 and uses the received clock signal to discipline its local clock signal, and so on. When one of the compute nodes 12 is designated as a master clock, that compute node 12 does not use the clock signal received at its clock input port 26, but disciplines its local clock signal based on the remote clock 32 and outputs its local clock signal via its clock output port 28 to the next compute node 12 in the loop, and so on. Another option is to assign one of the compute nodes 12 as a default master clock.

Reference is now made to FIG. 8, which is a block diagram view of the clock synchronization system 40 of FIG. 7 with compute node 12-3 designated as the master clock. The master clock may be moved from one compute node 12 to another due to many reasons, for example, the remote clock 32 used by one of the compute nodes 12 previously designated as the master clock may now be non-functional or deemed to be less accurate than a remote clock used by another one of the compute nodes 12 now designated as the master clock.

In the example of FIG. 8, the compute node 12-3 is now designated as the master clock (for example, by the controller 14), and disciplines its local clock signal from the remote clock 32. The compute node 12-3 may: ignore any clock signal received at its clock input port 26; or the controller 14 may instruct the compute node 12-2 to cease outputting the local clock signal of compute node 12-2 via the clock output port 28 of compute node 12-2. The compute node 12-3 distributes its local clock signal as the master clock frequency via the clock output port 28 of compute node 12-3 to the clock input port 26 of the compute node 12-1. The compute node 12-1 disciplines its local clock signal responsively to the received clock signal received at the clock input port 26 of compute node 12-1. The compute node 12-1 distributes its local clock signal as the master clock frequency via the clock output port 28 of compute node 12-1 to the clock input port 26 of compute node 12-2. The compute node 12-2 disciplines its local clock signal responsively to the received clock signal received at the clock input port 26 of compute node 12-2. As mentioned above, in some embodiments, the compute node 12-2 is instructed by the controller 14 not to distribute its local clock signal via the clock output port 28 of compute node 12-2. In other embodiments, the compute node 12-2 distributes its local clock signal as the master clock frequency via the clock output port 28 of compute node 12-2 to the clock input port 26 of compute node 12-3, which is instructed by the controller 14 to ignore the received clock signal received at the clock input port 26 of compute node 12-3.

In some embodiments, the controller 14 is configured to run a software daemon which knows the topology of the system 40 (i.e., how the compute nodes 12 are connected in the closed loop) and which compute node 12 is the master clock (e.g., SyncE master) so that the software daemon knows where to block and unblock the closed loop. If the compute nodes 12 are disposed in different hosts, then the hosts may need to communicate with respect to blocking and unblocking the closed loop.

The controller 14 is configured to identify or designate one of the compute nodes 12 as the master clock. The controller 14 is configured to selectively block and unblock distribution of the master clock frequency in the closed loop responsively to one of the compute nodes 12 being designated as a master clock. In some embodiments, the controller 14 is configured to instruct the clock synchronization circuitry 20 of the compute node 12 designated as the master clock to ignore the clock signal received at its clock input port 26 responsively to that compute node 12 being designated as the master clock. In other embodiments, the controller 14 is configured to instruct the clock synchronization circuitry 20 of the compute node 12 (designated as a slave clock prior and) located immediately prior to the compute node 12 designated as the master clock in the closed loop to not send its local clock signal via its clock output port 28 to the compute node 12 designated as the master clock.

Reference is now made to FIG. 9, which is a block diagram view of processing circuitry 16 of the compute nodes 12 for use in the system 10 of FIG. 1. The processing circuitry 16 may include any one or more of the following: a NIC ASIC 42, a CPU 44, a GPU 46, and network switch circuitry 48. Therefore, the compute nodes 12 may include: corresponding network interface controllers; and/or corresponding central processing units; and/or corresponding graphic processing units; and/or corresponding network switches.

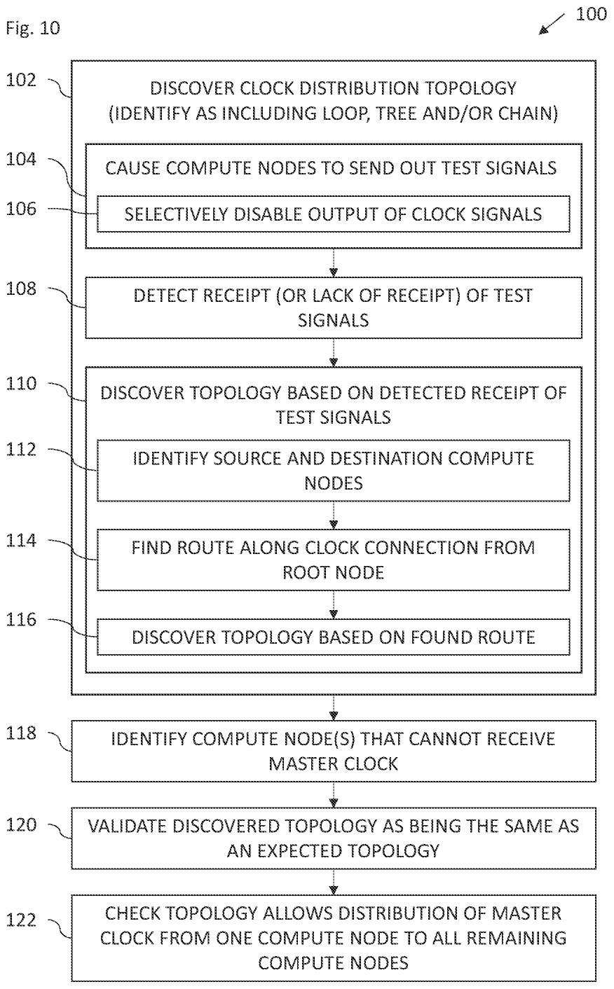

Reference is now made to FIG. 10, which is a flowchart 100 including steps in a method to discover a clock distribution topology for use with system 10 of FIG. 1 or with system 40 of FIG. 7 or with any suitable clock synchronization system. The steps described below are described as being performed by the controller 14 for the sake of simplicity. It should be noted that the steps described below may be performed by any suitable processor or processors, for example, the processing circuitry 16 of one of the compute nodes 12 or a CPU, for example, in a host of one of the compute nodes 12.

The controller 14 is configured to discover a clock distribution topology formed by compute nodes 12 and the clock connections 30 (block 102). In some embodiments, each clock connection 30 is configured to send clock signals in one direction only defined by the clock input port 26 and clock output port 28 to which each clock connection 30 is connected. If the clock topology includes a loop of clock connections 30, the controller 14 is configured to identify the discovered clock distribution topology as including a loop topology wherein the clock connections 30 connect the compute nodes 12 in a loop such that the compute nodes 12 are configured to distribute the master clock around the loop from one of the compute nodes 12 to another one of the compute nodes 12, as shown in FIG. 5. If the clock topology includes a chain topology, the controller 14 is configured to identify the discovered topology as including a chain topology wherein the clock connections 30 connect the compute nodes 12 in a chain such that the compute nodes 12 are configured to distribute the master clock along the chain from one of the compute nodes 12 to another one of the compute nodes 12, as shown in FIG. 1. If the clock topology includes a tree topology, the controller 14 is configured to identify the discovered topology as including a tree topology wherein the clock connections 30 connect the compute nodes from a root node of the compute nodes 12 to other ones of the compute nodes 12. The controller 14 may identify any suitable topology type, such as tree, chain or loop, or any suitable combination thereof. For example, the identified topology may include a tree topology with one or more subloops.

The controller 14 is configured to cause the compute nodes 12 to send out test signals along the clock connections 30 (block 104). In some embodiments, the controller 14 is configured to selectively disable output of clock signals (sent along the clock connections 30) generated by the compute nodes 12 in order to enable the compute nodes 12 to output the clock signals one at a time to yield the test signals (block 106). For example, all the clock signals are disabled by the controller 14, and then enabled one by one, such that a first compute node 12 sends a test signal for a period of time, and then a second compute node 12 sends a test signal for a next period of time, and so on. During each period of time, receipt of the test signal is checked by the compute nodes 12, as described in more detail below.

The clock signals may include pulses (e.g., PPS signals) that indicate clock times of the respective senders of the clock signals. In some cases, the clock signals may have respective frequencies indicative of clock frequency of the respective senders of the clock signals. During the test phase described above with reference to the step of blocks 104 and 106, the clock times or frequencies indicated by the senders are generally not used by the receiver of the signals. However, during clock synchronization, the clock times or frequencies indicated by the clock signals are used. For example, if a PPS signal pulse is sent every second on the second then the receiver of that signal may infer the clock time of the sender from that signal while taking into account the delay in sending the signal from the sender to the receiver. For example, if a clock signal having a given frequency is sent by a sender to a receiver, then the receiver may infer that the frequency of the clock of the sender of the clock signal is equal to, or proportional to, the given frequency of the clock signal.

The compute nodes 12 are configured to detect receipt of the test signals. Each compute node may include hardware logic such as clock synchronization circuitry 20 or processing circuitry 16 configured to determine receipt, or lack of receipt, of one of the test signals (block 108). For example, when a PPS pulse is received by the clock input port 26 of one of the compute nodes 12, the time of arrival is logged (e.g., in memory) and/or the clock synchronization circuitry 20 sends an interrupt to software running on the processing circuitry 16 or on the controller 14. Additionally, if receipt of a PPS pulse is not detected by a compute node 12 within a given time period (e.g., within 2 seconds), it may be assumed that a PPS pulse was not sent to that compute node 12. If the compute node 12 includes frequency synchronizer 23, the frequency synchronizer 23 detects a clock-in signal and provides an indication that a clock-in signal has been received. In some cases, for example, when the oscillator 24 and physical hardware clock 22 are replaced with a DCO, the clock signal received by clock input port 26 is processed by the clock synchronization circuitry 20 (which may be in a NIC ASIC) and the clock synchronization circuitry 20 checks for receipt of the clock signal. The software running on the processing circuitry 16 or the controller 14 may poll the frequency synchronizer 23 via the clock synchronization circuitry 20 or poll the clock synchronization circuitry 20 (e.g., when the DCO is included) to determine if a clock signal is being received. In some embodiments, the clock synchronization circuitry 20 may provide an interrupt signal to the software to indicate that a clock signal is being received.

The controller 14 is configured to discover the clock distribution topology based on the detected receipt of the test signals (block 110). The controller 14 is configured to identify source and destination compute nodes 12 of the test signals based on the detected receipt of the test signals (block 112). The controller 14 is configured to find one or more routes along the clock connections 30 from a root node of the compute nodes 12 to all remaining ones of the compute nodes 12 based on the identified source and destination compute nodes 12 of the test signals (block 114). The controller 14 is configured to discover the topology based on the found route(s) (block 116).

The controller 14 may be configured to identify one (or more) of the compute nodes 12 that cannot receive the master clock, e.g., from a root node of the compute nodes 12 (block 118). The controller 14 may be configured to validate the discovered clock distribution topology as being the same as an expected clock distribution topology (block 120). The controller 14 may be configured to check that the discovered topology allows distribution of the master clock from one of the compute nodes 12 to all remaining ones of the compute nodes 12 (block 122).

The steps of blocks 102-122 are now illustrated with reference to the example of FIG. 4. Reference is also made to FIG. 10. FIG. 4 shows four compute nodes, compute node A, compute node B, compute node C, and compute node D. The controller 14 disables all the clock out signals generated by compute nodes A-D. If any of the compute nodes A-D detects an incoming clock signal, then it indicates that another compute node is acting as a clock signal source to that compute node and there is a problem with the clock distribution topology. The controller 14 then enables the clock out signal of compute node A. The controller 14 determines which of the compute nodes received the clock out signal. In this example, the clock signal is detected as received by compute node B. The controller 14 then deactivates the clock out signal generated by compute node A, and activates the clock out signal generated by compute node B. The controller 14 determines which of the compute nodes received the clock out signal. In this example, the clock signal is detected as received by both compute node C and compute node D. The controller 14 then deactivates the clock out signal generated by compute node B, and activates the clock out signal generated by compute node C. The controller 14 determines which of the compute nodes received the clock out signal. In this example, the clock signal is not detected by any of the compute nodes. The controller 14 then deactivates the clock out signal generated by compute node C, and activates the clock out signal generated by compute node D. The controller 14 determines which of the compute nodes received the clock out signal. In this example, the clock signal is not detected by any of the compute nodes. The found topology from the above example may be described by the following table:

| Device | Feeding | Fed by |
|---|---|---|
| NODE A | NODE B | None |
| NODE B | NODE C, D | NODE A |
| NODE C | None | NODE B |
| NODE D | None | NODE B |

Given an expected topology such as the topology shown in the above table, the expected topology may be verified using a validation or discovery process as follows. First, the controller 14 disables the clock out signal of all compute nodes A-D. If any of the compute nodes detects an incoming clock signal, then it indicates that another compute node is acting as a clock signal source. Next, the controller 14 enables the clock out signal of compute node A and verifies that only compute node B receives the clock out signal. Then, the controller 14 disables the clock out signal of compute node A, and enables the clock out signal of compute node B and verifies that the clock out signal is only received by compute nodes C and D. Then, the controller 14 disables the clock out signal of compute node B, and enables the clock out signal of compute node C and verifies that the clock out signal is not received by any of the compute nodes. Then, the controller 14 disables the clock out signal of compute node C, and enables the clock out signal of compute node D and verifies that the clock out signal is not received by any of the compute nodes.

The above validation may be repeated intermittently or whenever a wiring issue is suspected, in order to verify that the connectivity is still providing the expected clock distribution topology, and/or that the hardware works properly. The validation may also indicate whether a cable has become disconnected or has stopped working.

The connectivity described in a topology table (e.g., shown in the above table) may be used to verify that the connectivity is valid for the clock synchronization method to be used. For example, if the clock synchronization method supports and uses a tree topology, the controller 14 may verify that there is a compute node (e.g., root node) which is able to feed all other compute nodes 12, either via a direct connection, or indirectly via one or more compute nodes 12. The root node will then act as the local clock synchronization master. For example, if the clock synchronization method supports and uses a loop topology, the controller 14 may verify that each compute node 12 can act as the local clock synchronization master, and therefore each compute node 12 should be able to feed a clock signal to all other compute nodes 12, either via a direct connection, or indirectly via one or more compute nodes 12.

If the controller 14 finds validation errors while discovering the topology, or validating an expected topology, or verifying that a clock synchronization method works with a given topology, the validation errors may be reported to a system administrator.

In practice, some, or all of the functions of the controller 14 may be combined in a single physical component or, alternatively, implemented using multiple physical components. These physical components may comprise hardwired or programmable devices, or a combination of the two. In some embodiments, at least some of the functions of the controller 14 may be carried out by a programmable processor under the control of suitable software. This software may be downloaded to a device in electronic form, over a network, for example. Alternatively, or additionally, the software may be stored in tangible, non-transitory computer-readable storage media, such as optical, magnetic, or electronic memory.

Various features of the invention which are, for clarity, described in the contexts of separate embodiments may also be provided in combination in a single embodiment. Conversely, various features of the invention which are, for brevity, described in the context of a single embodiment may also be provided separately or in any suitable sub-combination.

The embodiments described above are cited by way of example, and the present invention is not limited by what has been particularly shown and described hereinabove. Rather the scope of the invention includes both combinations and sub-combinations of the various features described hereinabove, as well as variations and modifications thereof which would occur to persons skilled in the art upon reading the foregoing description and which are not disclosed in the prior art.

What is claimed is:

1. A system, comprising:
a plurality of compute nodes;
clock connections to connect at least some of the compute nodes and to distribute a master clock among the at least some compute nodes; and
processing circuitry to discover a clock distribution topology formed by the compute nodes and the clock connections.

2. The system according to claim 1, wherein the processing circuitry is to identify the discovered clock distribution topology as including a loop topology wherein the clock connections connect the compute nodes in a loop such that the compute nodes are configured to distribute the master clock around the loop from one of the compute nodes to another one of the compute nodes.

3. The system according to claim 1, wherein the processing circuitry is to identify the discovered topology as including a chain topology wherein the clock connections connect the compute nodes in a chain such that the compute nodes are configured to distribute the master clock along the chain from one of the compute nodes to another one of the compute nodes.

4. The system according to claim 1, wherein the processing circuitry is to identify the discovered topology as including a tree topology wherein the clock connections connect the compute nodes from a root node of the compute nodes to other ones of the compute nodes.

5. The system according to claim 1, wherein the processing circuitry is to identify the discovered topology as including a tree topology, a chain topology, and a loop topology.

6. The system according to claim 1, wherein the processing circuitry is to validate the discovered clock distribution topology as being the same as an expected clock distribution topology.

7. The system according to claim 1, wherein the processing circuitry is to check that the discovered topology allows distribution of the master clock from one of the compute nodes to all remaining ones of the compute nodes.

8. The system according to claim 7, wherein the processing circuitry is to identify one of the compute nodes that cannot receive the master clock from a root node of the compute nodes.

9. The system according to claim 1, wherein:
the processing circuitry is to cause the compute nodes to send out test signals along the clock connections;
the compute nodes are to detect receipt of the test signals; and
the processing circuitry is to discover the topology based on the detected receipt of the test signals.

10. The system according to claim 9, wherein the processing circuitry is to:
identify source and destination compute nodes of the test signals based on the detected receipt of the test signals;
find at least one route along the clock connections from a root node of the compute nodes to all remaining ones of the compute nodes based on the identified source and destination compute nodes of the test signals; and
discover the topology based on the found at least one route.

11. The system according to claim 9, wherein the processing circuitry is to selectively disable output of clock signals generated by the compute nodes in order to enable the compute nodes to output the clock signals one at a time to yield the test signals.

12. The system according to claim 11, wherein the clock signals include pulses that indicate clock time.

13. The system according to claim 12, wherein the clock signals are n pulse per second (PPS) signals, wherein n is a positive integer.

14. The system according to claim 11, wherein the clock signals have a frequency indicative of clock frequency.

15. The system according to claim 9, wherein each of the compute nodes includes hardware logic to determine receipt, or lack of receipt, of one of the test signals.

16. The system according to claim 1, where the distributed master clock is indicative of a frequency of a master clock.

17. The system according to claim 1, wherein the distributed master clock is indicative of a time of a master clock.

18. The system according to claim 1, wherein the compute nodes include corresponding network interface controllers.

19. The system according to claim 1, wherein the compute nodes include corresponding central processing units.

20. The system according to claim 1, wherein the compute nodes include corresponding graphic processing units.

21. The system according to claim 1, wherein the compute nodes include corresponding network switches.

22. A method, comprising:
connecting compute nodes with clock connections to distribute a master clock among the compute nodes; and
discovering a clock distribution topology formed by the compute nodes and the clock connections.
